(19) United States
(12) Patent Application Publication
(10) Pub. No.: US 2005/0201525 A1
(43) Pub. Date: Sep. 15, 2005

(54) Telecommunications service provisioning and administrative process

(76) Inventor: Douglas Hudson, Millersville, MD (US)

Correspondence Address: SWIDLER BERLIN LLP, 3000 K STREET, NW, BOX IP, WASHINGTON, DC, 20007, US

(21) Appl. No.: 10/795,985

(22) Filed: Mar. 10, 2004

(51) Int. Cl. H04M 1/24; H04M 3/08

(52) U.S. Cl. 379/1.01; 379/32.01; 379/111

(57) ABSTRACT

A system and method of allocating financial and functional responsibilities of joint-use local access facilities, that are provided by and to telecommunications service providers is described. Service providers disclose their local access service requirements to an administrator who has responsibility for collecting the data and releasing it only in aggregated form that protects the proprietary interests of the disclosing parties. In addition, a system and method is provided to assign a status to each of the participating telecommunications service providers, in which each of them will, at various times, serve the other participants as either a serving party or a purchasing party, with specific responsibilities in each case. When a telecommunications service provider functions as the serving party, it provides certain specific services under terms and conditions, and according to certain technical specifications, that are set forth as part of the system and methods that are disclosed. When a participating telecommunications service provider functions as a purchasing party, it adheres to certain routinized processes for ordering service and submitting payment, all according to pre-determined terms and conditions that are disclosed. Methods for solving problems and settling disputes between the participants are also described.

### FIELD OF THE INVENTION

The present invention relates to the provisioning of telecommunications services and, more particularly to identifying buildings that are under-served by telecommunications connections and provisioning telecommunications services within those buildings according to the result of an administrative process.

### BACKGROUND OF THE INVENTION

The provisioning of telecommunications services has historically involved capital intensive efforts that have limited the introduction of competing services, except in markets with very high population densities, where an adequate return on the investment can be predicted. For these reasons, many tenants of apartment and office buildings in the United States still lack sufficient service provisioning to allow high-speed internet access and other services that individuals and businesses in other locations may enjoy.

There is a general problem associated with wiring apartment and other buildings for telecommunications services. That is, tenants in apartment and office buildings may use telecommunications services that are provided by many different companies. Thus, no one company has an idea of the volume of telecommunications services that are being provided to the building and thus there is a lack of information available to determine whether any particular building is a good candidate for improvements and expansion of its telecommunications infrastructure. In addition, there is a tremendous diversity in the management of buildings in any given area. The management of each building has a monopoly over its building and thus may impose costs on infrastructure improvements that vary greatly from building to building. For these reasons, it is sufficiently difficult to collect information on the costs of telecommunications infrastructure in buildings, and this difficulty has resulted in a neglected market for telecommunications infrastructure improvements.

Accordingly, there is a need for a system and method for collecting data on buildings that may be good candidates for telecommunications infrastructure improvements. There is a further need for a system and method that analyzes the collected data to identify buildings that are good candidates for infrastructure improvements. There is a still a further need for a system and method to encourage diverse telecommunications service providers to make telecommunications infrastructure improvements in buildings that in the absence of the system would not be made.

### SUMMARY OF THE INVENTION

According to the present invention, telecommunications service providers in a given geographic area, such as New York City, provide cost information on telecommunications services that they provide to tenants in buildings to a neutral administrator. The administrator collects the data from various telecommunications service providers in a database and aggregates the data to determine the volume of telecommunications service provided on a building-by-building basis. The administrator distributes aggregated data on a building-by-building basis to members. Members evaluate the aggregated and, when desirable, identify themselves as a potential charter member for individual buildings. The administrator grants charter member status to potential members based on established criteria. The charter member builds out the telecommunications infrastructure in the building and the other members compete to provide telecommunications services to tenants in the building using the new telecommunications infrastructure. In this manner, data that is generally unavailable is collected and used to assign a charter status to one member of the group that encourages infrastructure investment that otherwise would not be made.

According to one embodiment of the present invention, a method of collecting and aggregating telecommunications data includes collecting telecommunications demand information from a plurality of members. The telecommunications demand information is then aggregated and distributed to at least some of the members. Potential charter members are then identified from among the members as candidates for constructing the telecommunications infrastructure of particular buildings represented in the demand information. A charter member is then selected based on predetermined criteria.

The aggregating may include identifying the demand information on a building-by-building basis. The telecommunications demand information may illustratively include local access circuit counts, capacity of telecommunications circuits purchased in the building (often measured in “voice grade equivalents”), volume of minutes for local access, purchasing volume of wholesale circuits and unbundled network elements, or other types of telecommunications indicators. The potential charter members may be identified on a building-by-building basis based on each member's present facilities for providing local access to the building. The winning charter member may be selected from among the potential charter members based on a scoring routine. Once the charter member is established, the charter member provides a local access connection between the building in which the charter is held and a central communications hub that is located in the same metropolitan area, over a charter member's communications link. The hub may be maintained by a neutral party and is the interconnection facility for interconnecting other members with charter members to provide service to customers in the charter members' buildings.

A method of enhancing telecommunications infrastructure in buildings according to another embodiment of the present invention may include collecting demand sets for a building from a group of telecommunications service providers, each being a member and then assigning charter member status to one of the members. A telecommunications path operated by the charter member is connected between a neutral interconnection hub and potential customers in the building. The charter member's path is then made available for use by any member to service potential customers through interconnection between that member and the neutral hub.

According to still another embodiment of the present invention, a system of providing telecommunications infrastructure to a building includes an administrator system, a hub and an interconnection system. The administrator system selects a charter member for constructing and installing telecommunications infrastructure within a building. The hub connects a telecommunications path of the charter member to a plurality of purchasing members in order to provide access to customers in the charter member's building. The interconnection system is coupled with the administrator system and maintains a list of interconnections at the hub between purchasing members connected to charter members at the hub. The hub may be maintained by a neutral party for the members. In addition, termination facilities may be provided in the building, maintained by the neutral party, for connecting a purchasing member's customer in the building to the charter member's path.

### BRIEF DESCRIPTION OF THE FIGURES

The above described features and advantages of the present invention will be more fully appreciated with reference to the detailed description and Figures, in which:

FIG. 1 depicts a system for establishing telecommunications infrastructure according to an embodiment of the present invention.

FIG. 2 depicts a block diagram of interconnections among members that are presently providing telecommunications services to buildings in a geographic area according to an embodiment of the present invention.

FIG. 3 depicts a process for collecting information from members and assigning charter member status to one of the members, according to an embodiment of the present invention.

FIG. 4 depicts a method of selecting a charter member from among a plurality of potential charter members.

FIG. 5 depicts an assignment of points that may be used to score potential charter members for use in selecting a charter member according to an embodiment of the present invention.

FIG. 6 depicts a further system for assigning points that may be used to score potential charter members for use in selecting a charter member according to an embodiment of the present invention.

FIG. 7 depicts a further system for assigning points that may be used to score potential charter members for use in selecting a charter member according to an embodiment of the present invention.

FIG. 8 depicts a method of ordering services using new telecommunications infrastructure among interconnected members according to an embodiment of the present invention.

FIG. 9 depicts a system for interconnecting purchasing member and charter members at a hub according to an embodiment of the present invention.

FIG. 10 depicts a system for interconnecting purchasing members and charter members within a building according to an embodiment of the present invention.

### DETAILED DESCRIPTION

According to the present invention, telecommunications service providers in a given geographic area, such as New York City, provide cost information on telecommunications services that they provide to tenants in buildings to a neutral administrator. The administrator collects the data from various telecommunications service providers in a database and aggregates the data to determine the volume of telecommunications service provided on a building-by-building basis. The administrator distributes aggregated data on a building-by-building basis to members.

Members evaluate the aggregated data and, when desirable, identify themselves as a potential charter member for individual buildings. The administrator grants charter member status to potential members based on established criteria. The charter member builds out the telecommunications infrastructure in the building and the other members compete to provide telecommunications services to tenants in the building using the new telecommunications infrastructure. In this manner, data that is generally unavailable is collected and used to assign a charter status to one member of the group that encourages infrastructure investment that otherwise would not be made.

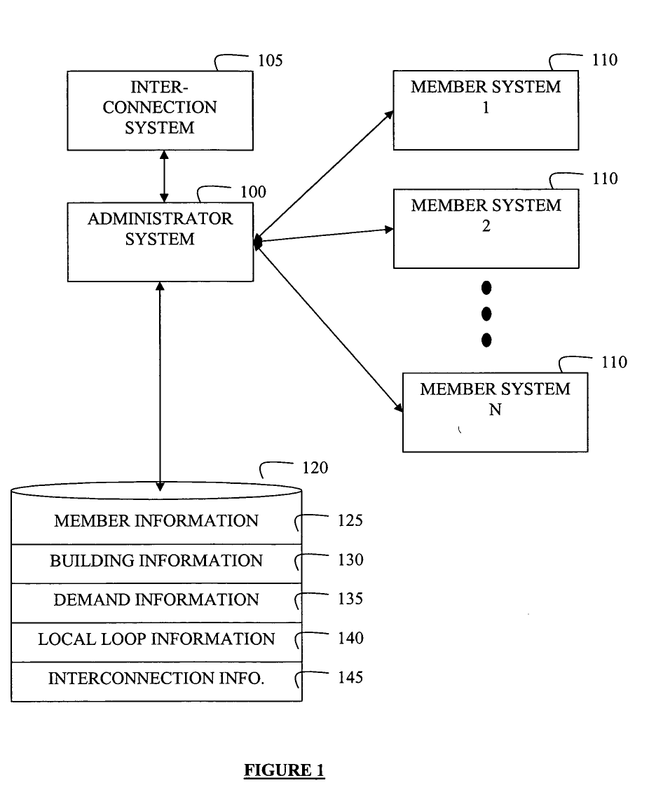

FIG. 1 depicts a system for provisioning new telecommunications services according to an embodiment of the present invention. Referring to FIG. 1, an administrator system 100 is coupled to an interconnection system 105, a database 120 and a plurality of member systems 110. The administrator system 100 and member systems 110 may be general purpose computer systems and each of the interconnections between systems shown may be made through a network, such as an internet protocol network, a wireless network, an optical network, or any other convenient manner of interconnecting computers or their peripherals to each other and/or to a network.

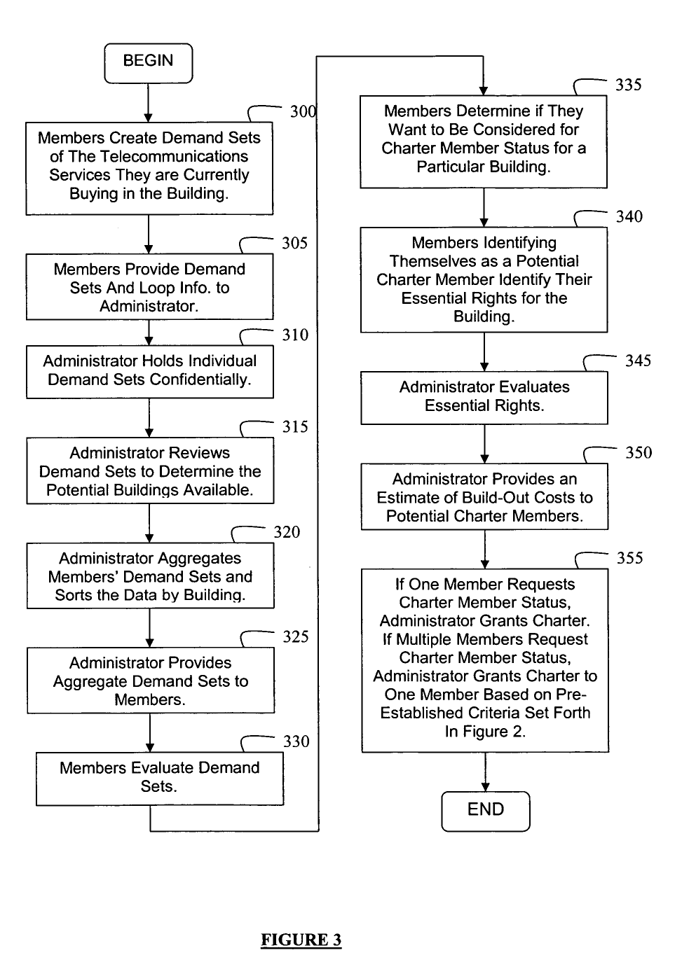

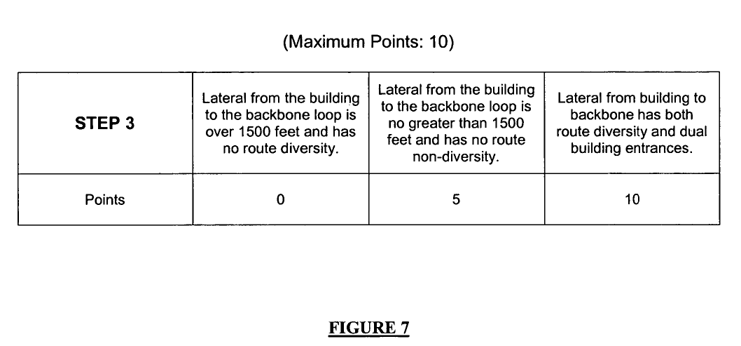

The administrator system 100 is operative to interact with the systems to which it is coupled and carry out the method steps illustrated in FIGS. 3-8. The member systems 110 are each maintained by a corresponding telecommunications service provider. Each member system 110 may be coupled to the database that maintains the telecommunication service provider's financial information. In general, the member system is used to collect financial information from the telecommunications service provider regarding the telecommunications service provider's service usage in a given geographic area in such a manner that it may be used to identify that service providers usage on a building-by-building basis. This information, termed a demand set, may include: local access circuit counts, capacity of telecommunications circuits purchased (often measured in “voice grade equivalents”), volume of minutes for local access, purchasing volume of wholesale circuits and unbundled network elements, or other types of telecommunications indicators.

The collection of data or information that comprises the demand set may done by a process on the member system that interacts with the telecommunications service provider's financial information databases to extract information and place it into a demand set format suitable for use by the administrator system 100.

Once the demand set has been collected on the member system 110, it is transmitted to the administrator system 100. The administrator system 100 receives demand sets from each member system 110 and aggregates the demand sets according to a process described herein. The administrator system may also exchange messages with the member systems alerting the member systems of buildings that are designated for a charter member competition according to the present invention and to exchange other pertinent information, such as membership information, with member systems 110.

The administrator system 100 also communicates with the database 120. The database 120 may be used to store pertinent information. For example, the database 120 may include member information 125. The member information generally comprises billing information for each member, the status of the member's membership and any other convenient information. The database may further include building information 130, such as the address of buildings identified by the system, information on the building's management, information on which members are currently providing telecommunications service to some of the building, the size of the building, and other pertinent information. The demand information 135 may include the demand sets provided by each member system 110 according to the present invention and may further include aggregated demand sets broken down by building, by member, service type or in any other convenient manner. The local loop information 140 may include information that describes the extent of the local loop in a given geographic area of each subscriber, which buildings that local loop serves directly and which buildings the loop serves that may be used for interconnection to the administrator system. The interconnection information database 145 is used to store information describing the interconnection between the administrator's interconnection node and the node of every member. This interconnection information may be stored on a wire by wire basis.

The interconnection system 105 is coupled to the administrator system 100. It may be used to generate interconnection orders for interconnecting the administrator node to purchasing member nodes or to charter member nodes in order to enable the provision of telecommunications services between members and charter members according to an embodiment of the present invention. Alternatively, the interconnection system itself might comprise an automated system for interconnecting the administrator node to the appropriate purchasing member and/or charter member node.

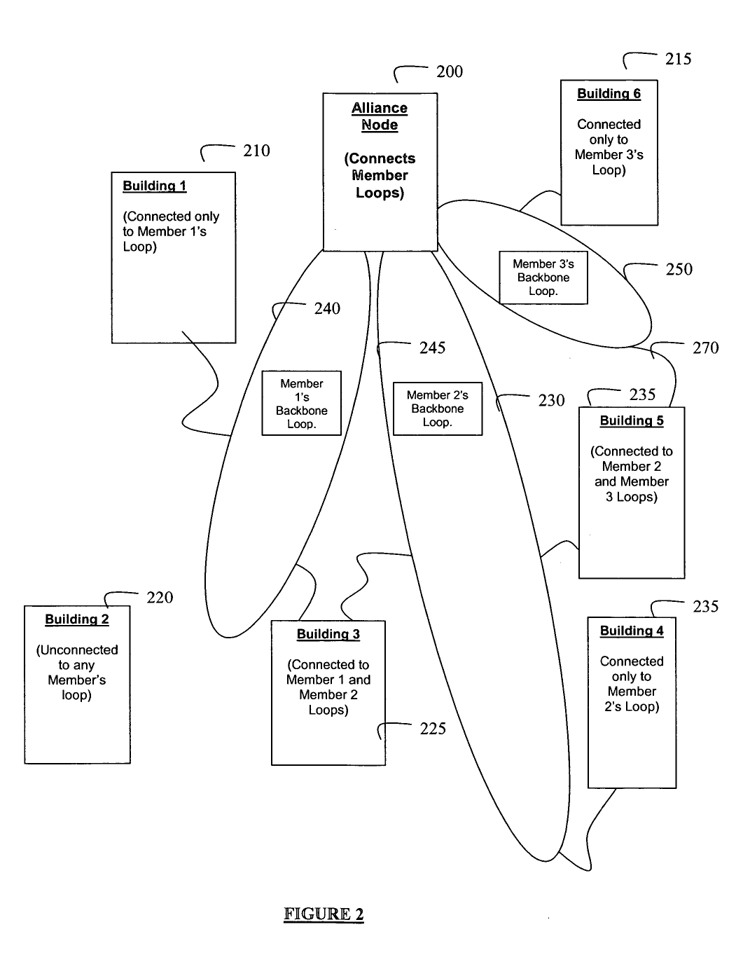

FIG. 2 depicts an illustrative block diagram of provisioning interconnections among buildings in a given geographic area according to an embodiment of the present invention. Referring to FIG. 2, in a given geographic area, such as New York City, there are a plurality of buildings to which members are presently providing telecommunications services. The buildings are served, in the example shown, by backbone local loops 240, 245 and 250 corresponding to three different telecommunications service providers who are members of an alliance according to the present invention. The backbone loops may be optical fiber, copper, or any other convenient communications links. The backbone loop 240 is owned or operated by one alliance member and is coupled, for example, to buildings 210, 225 and to the alliance building or node 200. The backbone loop 245 is owned or operated by another member and is coupled to buildings 235, 255 and the alliance building or node 200. The backbone loop 250 is owned or operated by still another member and is coupled to building 255, 215 and the alliance building or node 200. Each of the loops is coupled to the building over a lateral between the loop and the building.

Not every building is connected to every loop for a variety of reasons, including that the building management generally does not allow every service provider with a backbone to establish a lateral connection to the building, because an easement is generally required run a lateral in order to access a building from a loop and a variety of other reasons. Accordingly, as shown, buildings in a given geographic area are serviced by a variety of local loops maintained by separate telecommunications service providers. Building 220, for example, is not served by the local loop of any member. Building 215 is served by the backbone loop 250 associated with one of the members. Building 255 is served by the backbone loops 245 and 250 of respective members. Similarly, buildings 235 and 225 are served by two members.

Each of the member's loops also is connected to the alliance node 200. This path may be established by running the member's loop through the alliance node either directly or via a lateral connection. The alliance node is used to interconnect members through the administrator node according to an embodiment of the present invention.

FIG. 3 depicts a method of collecting information from members and assigning charter member status to one of the members, according to an embodiment of the present invention. Referring to FIG. 3, in step 300 the members create demand sets of the telecommunications services that they are currently providing and/or using in a given geographic area, such as New York City. The information may be collected by conducting database queries in the member's financial information databases and then formatting the demand sets according to a predetermined format. The predetermined format is generally provided by the administrator and is used to ensure the receipt of consistent and uniform information across the membership. The demand set information includes: local access circuit counts, capacity of telecommunications circuits purchased (often measured in “voice grade equivalents”), volume of minutes for local access, purchasing volume of wholesale circuits and unbundled network elements, or other types of telecommunications indicators.

After the demand set information has been created, then in step 305, the information is provided to the administrative system 100. This may be done in a variety of ways. The administrative system 100 may send a query to the member systems 110 which respond by transmitting a message including the demand set information back to the administrative system. The member systems 110 may transmit the demand set information over a network connection to the administrative system 100. Alternatively, the demand set information may be provided at regular intervals, such as monthly or yearly intervals between the member systems 110 and the administrator system 100. The member also provides loop information from the member system to the administrative system, which may also be in a predetermined format.

In step 310, the administrator receives the demand sets from each member and prevents members from accessing the demand sets of other members. The administrator also receives the loop information from each member. In step 315, the administrator identifies potential buildings for infrastructure improvements. These buildings include those to which one of the members has a lateral connection from that member's loop. In step 320, the administrator system aggregates the demand sets of all of the members and determines a demand set on a building-by-building basis. This may include sorting the demand sets by building.

In step 325, the administrator system 100 provides the aggregated demand sets to the member systems 110. In step 330, the members evaluate the aggregated demand sets. The aggregated demand set information is provided, however, in a format that does not allow the members to determine cost or other information relating to telecommunications services provided by competitor members. In step 335, each member determine if it wants to be considered for charter member status for one or more particular buildings in which that member has a lateral connection to its backbone loop.

In step 340, the member system sends to the administrative system 100 an identification of the buildings for which the member would like to be considered as a charter member and identifies the essential rights of that member in each of those buildings. The essential rights may be identified according to a predetermined format and generally include easements or licenses across land and rights (through leasehold or license interests) to occupy telephone equipment rooms, cable risers and building entrance conduits, accompanied by rights to operate telecommunications facilities within the building. Essential rights, preferably, are currently valid and have a reasonable period of time remaining in their terms. The essential rights may be stored by the administrative system in the building information portion of the database 120.

In step 345, the administrator evaluates each potential charter member as a potential candidate for charter member status on a building-by-building basis. The administrator also provides an estimate of build out costs to potential charter members. The build out costs includes an estimate to provide telecommunications services to expand the potential charter member's existing service in the building to cover the entire building. In step 350, the administrator grants charter member status according to predetermined criteria. If there is only one potential charter member who meets the predetermined criteria, then the administrator, via the administrative system in any other convenient manner notifies the potential charter member that he is the charter member. Where multiple charter members are vying to become the charter member, the administrator conducts a scoring process for each charter member and awards the charter member status to the potential charter member with the highest score.

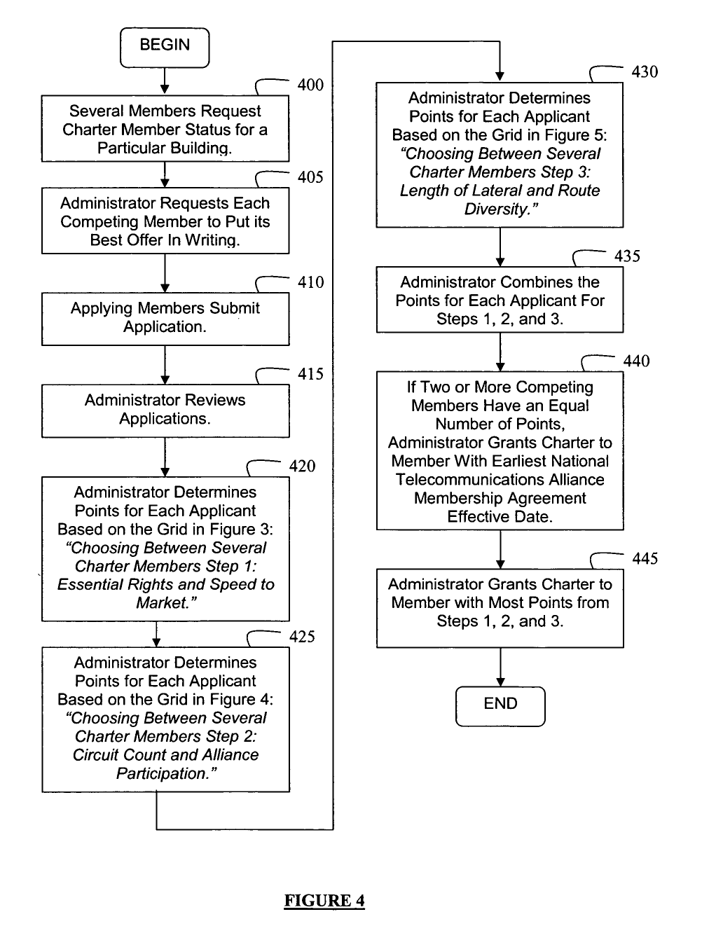

FIG. 4 depicts a method of selecting a charter member from among a plurality of potential charter members. Referring to FIG. 4, in step 400, several potential charter members request charter member status. In step 410, the administrator system sends a request to the member system 110 of each potential charter member requesting each competing member to put its best offer in writing. Thereafter, potential charter members submit a charter member application in a predetermined format and transmit the application information to the administrative system 100. The application information includes a description of the applicant's Essential Rights, desirable features of the potential Charter Member's telecommunications system, the applicant's commitments to upgrade facilities in the building, as well as a commitment as to how quickly the upgrades will be accomplished. The application also discloses any conditions the applicant may place on its willingness to become the charter member, such as the ability to negotiate a renewal of Essential Rights with the building's landlord. All of the application information may be reduced to a format that is common among members and the administrative system. In addition, scores or points may be associated with each item of application information identified in the format. In this manner, the administrator system may assign a score based on the application information. Processes other than scoring may be implemented, however, in order to select the charter member.

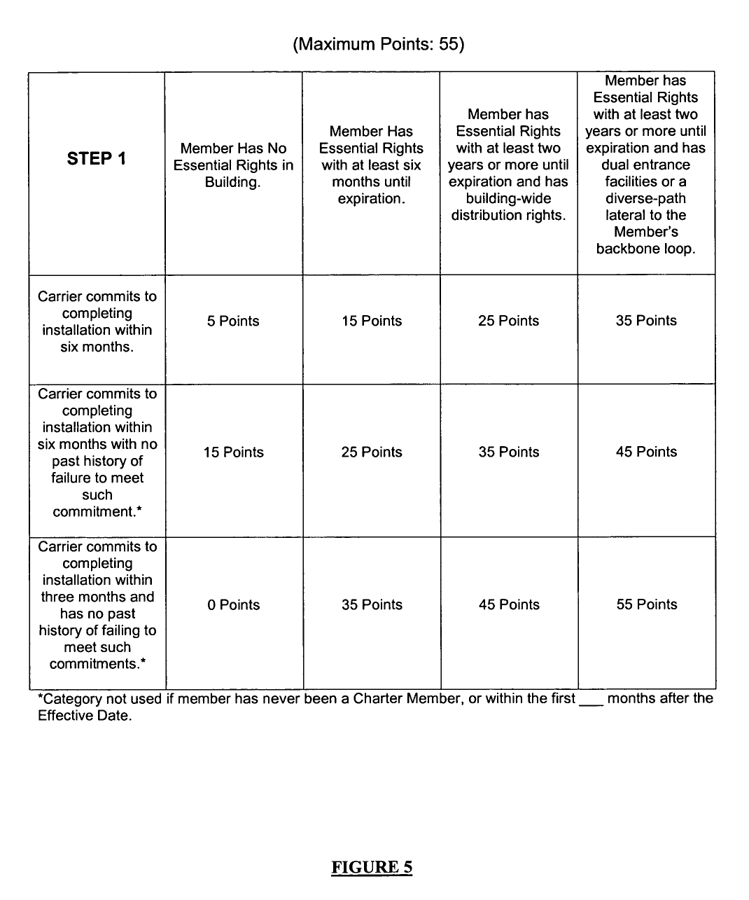

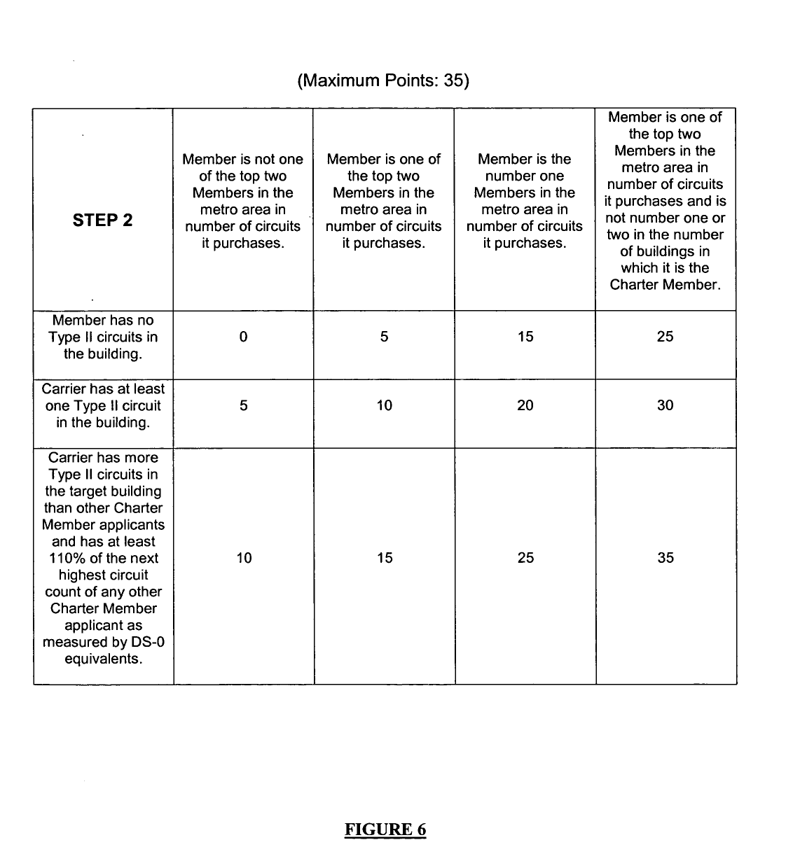

In step 415, the administrative system receives application information and the administrator reviews applications. In step 420, the administrator system 100 assigns points to each potential charter member, based on the application information provided by the member system, according to the scoring system shown in FIG. 5. In step 425, the administrative system assigns points, to each potential charter member, based on the application information provided by each member system according to the scoring system shown in FIG. 6. In step 430, the administrative system assigns points to each potential charter member, based on the application information provided by each member system, according to the scoring system shown in FIG. 6.

In step 435, the administrative system combines points determined in steps 420, 425 and 430 for each potential charter member. In step 440, if two or more potential charter members have the same score, then the administrative system awards the charter to the potential charter member whose membership information reflects the earliest membership date. In step 445, the administrative system 100 grants charter member status to the potential charter member with the most points.

Once the charter member has been selected, the charter member is obligated to build out the telecommunications infrastructure to establish local access connections to every tenant in the building. Alternatively, the charter member may be obligated to provide another type of telecommunications service connection to the entire building, such as an optical or other connection agreed upon by the charter member. The charter member is further obligated to establish a continuous connection between the administrator's node (or one of the administrator's nodes) in a geographic area and the building. In this manner, any other member may serve any potential customer in the building telecommunications services by making a connection to the charter member at the administrator's node. All members who desire to provide services via the new telecommunications infrastructure provided by the selected charter member according to the present invention connect to the buildings via connections to charter member facilities through administrator facilities in the administrator's node. In this manner, no members (who are competitors) are responsible for physically touching other members' facilities or coming into direct contact with any other members' customers, and all members may easily connect to the new telecommunications infrastructure by maintaining facilities in the administrator node.

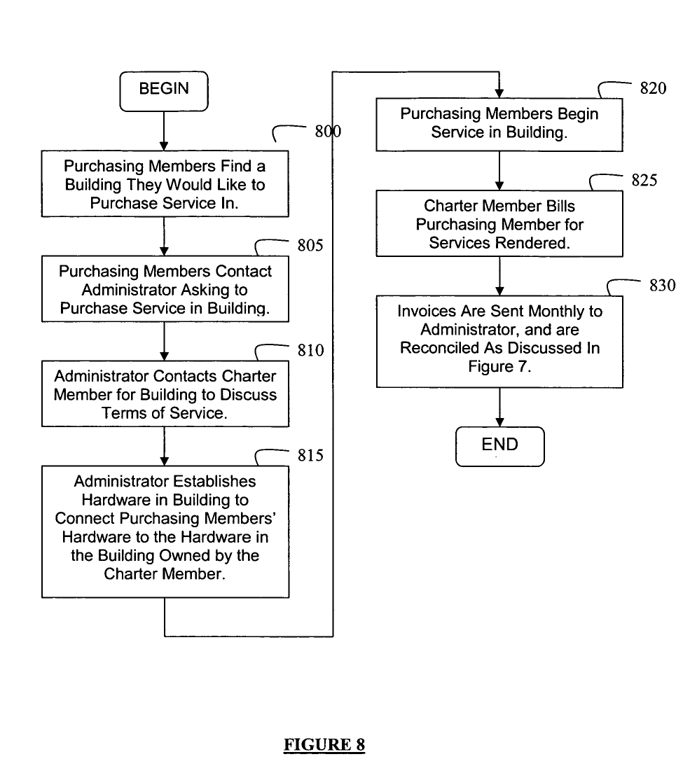

FIG. 8 depicts a method of interconnecting members at a hub according to an embodiment of the present invention. Referring to FIG. 8, in step 800, each purchasing member finds a building that it would like to purchase service in. In step 805, the purchasing member contacts the administrator asking to purchase telecommunications service using the new telecommunications infrastructure in a particular building. In step 810, the administrator sends information to the member system of the charter member to establish that there is a potential purchaser for services using the new telecommunications infrastructure. The charter member in turn establishes terms of service that are provided to the administrator system 100. Terms of service typically are that the purchasing member pays a fixed fee for service, monthly in advance, and a service cannot be disconnected without at least 30 days advance notice. Service must be installed within certain reasonable timeframes after a written request is received from the purchasing member, and compensation is provided for late installation or interruption of service after installation. In step 815, the administrator establishes facilities in the building to connect purchasing member's hardware to the charter member's facilities in the building. In step 820, the purchasing member begins providing service in the building. In step 825, the charter member bills the purchasing member for services rendered. In step 830, invoices are sent to either the purchasing member directly or via the administrator.

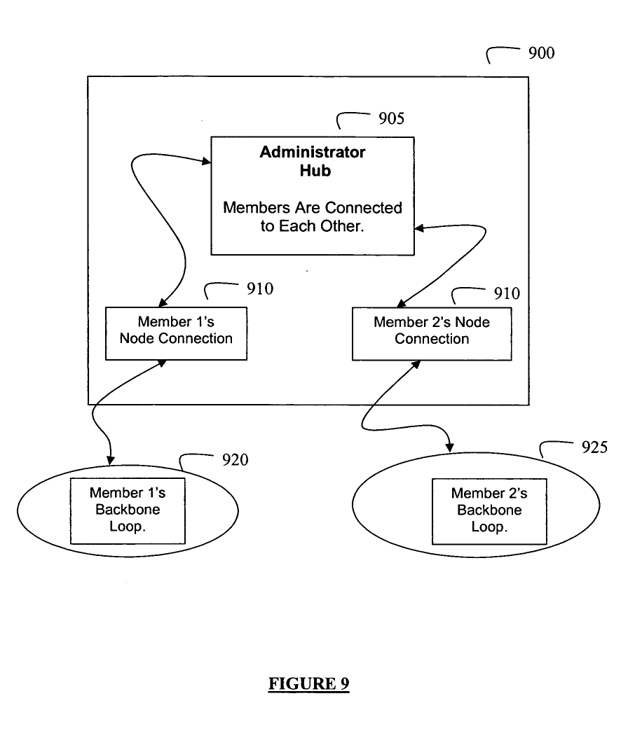

FIG. 9 depicts an administrator hub 900 according to an embodiment of the present invention. Referring to FIG. 9, the administrator hub 900 includes last mile connection facilities 905, and member connection facilities 910. Each member who has a backbone loop and who is a charter member maintains connection facilities 110 that connect a lateral from the backbone loop to the administrator facilities. All connections between members are made by the administrator using the administrator's facilities 905. All of the connection facilities may be patch panel facilities, cross connects or automated cross connects that allow for provisioning by commands from the administrator system or systems of the members. Members who do not have a backbone loop may nonetheless maintain connection facilities at the administrator hub 900 to connect to the backbone loop of other members through the administrator facilities 905. The connections may be electrical, optical or wireless, but are generally electrical.

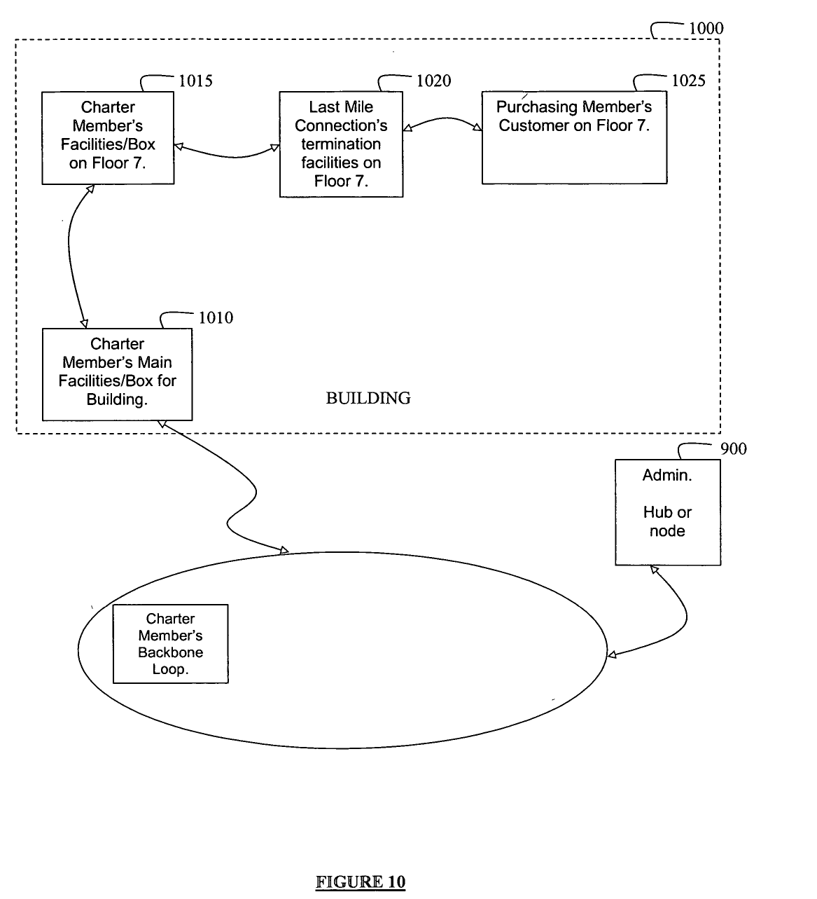

FIG. 10 depicts an embodiment of the present invention illustrating a telecommunications service path between the administrator node 900 and a purchasing member's customer according to an embodiment of the present invention. Referring to FIG. 10, the administrator node 900 is remotely located from a building 1000 in which a purchasing member has a customer that the purchasing member would like to provide telecommunications service to via the new telecommunications infrastructure established by the charter member and administrator. The telecommunications service path leads from the administrator hub, through the lateral and charter member's backbone loop to the lateral 1005 associated with the building 1000. The lateral brings the telecommunications service path to the charter member's main facilities box 1010 in the building. At this juncture, the path may be converted from optical to electrical. Alternatively, the path may remain optical.

Inside the building, the charter member may maintain only one facility 1010. Alternatively, the charter member may maintain additional interconnection facilities, such as, for example, one per floor. The charter member's interconnection facilities are in turn connected to the administrator's interconnection facilities 1020. The administrator may maintain an interconnection facility in the building in order to prevent the purchasing member from having to connect directly to the charter member, who may be a competitor. The purchasing member in turn connects its telecommunications wiring, or its customer's telecommunications wiring (which may be fiber optic) to the administrator's facilities. The purchasing member may also provide customer premises equipment that is connected to the administrator facility 1020. In this manner, a complete access path to a retail customer of a building is provided via new telecommunications infrastructure in a building that otherwise would not have been built due to costs involved. By contrast, the present invention provides a way to encourage charter members to invest in infrastructure improvements that benefit all members of a group that provides telecommunications service in a particular geographic area.

While particular embodiments of the present invention have been described, it will be understood by those having ordinary skill in the art that changes may be made to those embodiments without departing from the spirit and scope of the present invention.

1. A method of collecting and aggregating telecommunications data, comprising:
collecting telecommunications demand information from a plurality of members;
aggregating the telecommunications demand information;
distributing the aggregated information to at least some of the members;
identifying potential charter members from among the members for buildings; and
selecting a charter member based on predetermined criteria.

2. The method according to claim 1, wherein the aggregating includes identifying the demand information on a building-by-building basis.

3. The method according to claim 1, wherein the telecommunications demand information includes local access sales information.

4. The method according to claim 1, wherein the potential charter members are identified on a building-by-building basis based on each member's local access to the building.

5. The method according to claim 1, wherein the charter member is selected from among the potential charter members based on a scoring routine.

6. The method according to claim 1, further comprising:
providing a local access connection between a hub and each building over a charter member's communications link.

7. The method according to claim 6, further comprising:
providing an interconnection facilities maintained by a neutral party at the hub for interconnecting members with charter members at the hub.

8. The method according to claim 7, wherein the interconnection facilities include a cross connect owned by a neutral third party connected to each member and wherein the members are interconnected by interconnecting the cross connects of the neutral party.

9. A method of enhancing telecommunications infrastructure, comprising:
collecting demand sets for a building from a group of telecommunications service providers, each being a member;
assigning charter member status to one of the members;
connecting a telecommunications path operated by the charter member between a neutral interconnection hub and potential customers in the building; and
making the charter member's path available for use by any member to service potential customers through interconnection between that member and the neutral hub.

10. The method according to claim 9, further comprising:
assigning charter member status to one of a plurality of potential charter members based a score.

11. The method according to claim 10, wherein the score is determined based on application information provided by potential charter members.

12. The method according to claim 10, wherein the score is determined based on essential rights of the charter member.

13. A system of providing telecommunications infrastructure to a building, comprising:
an administrator system for selecting a charter member for building out telecommunications infrastructure within a building;
a hub for connecting a telecommunications path of the charter member to a plurality of purchasing members in order to provide access to customers in the charter member's building; and
an interconnection system, coupled with the administrator system, for maintaining a list of interconnections at the hub between purchasing members connected to charter members at the hub.

14. The system according to claim 13, wherein the hub is maintained by a neutral party for the members.

15. The system according to claim 14, further comprising termination facilities in the building, maintained by the neutral party, for connecting a purchasing member's customer in the building to the charter member's path.
